(19) United States
(12) Patent Application Publication
(10) Pub. No.: US 2017/0174861 A1
(43) Pub. Date: Jun. 22, 2017

(54) POLYURETHANE FOAM FOR CONCRETE APPLICATIONS

(71) Applicant: Brian Antone Cvetezar, Manitowoc, WI (US)

(72) Inventor: Brian Antone Cvetezar, Manitowoc, WI (US)

(21) Appl. No.: 15/447,017

(22) Filed: Mar. 1, 2017

Related U.S. Application Data
(62) Division of application No. 14/146,208, filed on Jan. 2, 2014, now abandoned.
(60) Provisional application No. 61/749,127, filed on Jan. 4, 2013.

(51) Int. Cl. C08J 11/24; C08G 18/72; C08J 9/36; E04G 23/02; E01C 23/10

(52) U.S. Cl. CPC C08J 11/24; E04G 23/0288; E01C 23/10; C08J 9/36; C08G 18/72; C08J 2375/04; C08G 2101/00

(57) ABSTRACT

A two-part polyurethane foam for lifting concrete. The two parts are mixed at a 1:1 ratio where the first part is isocyanate (“Part A”), and second part (“Part B”) is a polyol. The second part is comprised of recycled polyurethane foam and other polyols.

### CROSS-REFERENCE TO RELATED APPLICATIONS

This application is a divisional of U.S. patent application Ser. No. 14/146,208, filed on Jan. 2, 2014, which claims priority to U.S. Provisional Application No. 61/749,127, filed on Jan. 4, 2013.

### BACKGROUND OF THE INVENTION

Traditional mudjacking is a technique that has been used for decades to raise sunken concrete slabs. Mudjacking utilizes a cement-based grout mixture that is hydraulically pumped under a concrete slab. After the voids in the concrete slab are filled, the pressure from pumping in the material supports and lifts the concrete slab.

### SUMMARY OF THE INVENTION

Scrap material of polyurethane foam is widely available, in the form of foam trimmings, foam buns, foam skin, changeover blocks, off-specification material, polyurethane powder, molding mushrooms, fabrication scrap, post-consumer waste, or a combination thereof. The inventor has discovered that this recycled and reconditioned polyurethane foam scrap can be utilized to raise concrete slabs in lieu of the cement-based grout mixture. The polyurethane foam scrap is recycled and reconditioned into a two-part polyurethane foam that reacts and expands with enough force to fill voids, raise concrete, and underseal concrete slabs, foundations and structures.

The two-part polyurethane foam for lifting concrete is mixed at a 1:1 ratio. The two-part polyurethane foam includes part one, which is isocyanate (“Part A”), and part two (“Part B”) is a polyol. The polyol includes up to about 40% material made from recycled foam (such as old care seats, steering wheels and any type of cast off foam products). This recycled polyol is reconditioned by adding new polyols and during the reconditioning process, the resulting polyurethane foam is configured to have a particular density.

Polyurethane Foam=Part A (isocyanate)+Part B (recycled polyol and new polyols)

Density is defined by how much the finished product (“Part A” and “Part B” mixed together at a 1:1 ratio) weighs per cubic foot of finished material. When “Part A” and “Part B” are mixed together at a job site, a chemical reaction occurs causing the mixed materials to expand. When the mixed materials are injected under concrete slabs, the expansion force is strong enough to cause the concrete slabs to raise.

The two-part polyurethane foam includes several formulations with different densities and are designed for different applications. In one formulation, the polyurethane foam is light weight and fast reacting, which is ideal for residential concrete lifting. In another formulation, the polyurethane foam is of high density, which is ideal for lifting heavy slabs, such as highways and industrial flow projects with heavy traffic. Another formulation is used for joint stabilization and undersealing when material flow is required. In yet another formulation, a single component polyurethane foam is designed to bind and stabilize loose soils. One of the key benefits of using the recycled and reconditioned polyurethane foam is that it is preformulated with the characteristics needed for specific jobs. The two-part polyurethane foam formulations (e.g., 2, 3, 4, and 5 pound formulations) also feature a compressive strength of about 20 psi up to about 150 psi which may be necessary to hold the raised concrete in place no matter what the traffic or load that is applied to it.

In one aspect, the invention provides a method of manufacturing polyurethane foam for concrete lifting. The method includes depolymerizing a polyurethane scrap to form a polyurethane solution, subjecting the solution to propoxylation to form a polyol, and mixing the polyol with new polyol and isocyanate to form polyurethane foam.

In another aspect, the invention provides a system for manufacturing polyurethane foam for concrete lifting. The system includes a chemolysis reactor, a propoxylation reactor, and a mixer. The chemolysis reactor is capable of depolymerizing polyurethane scrap. The propoxylation reactor is connected to the chemolysis reactor and is capable of forming a polyol out of the depolymerized polyurethane scrap. The mixer mixes the polyol with new polyol and isocyanate to form polyurethane foam.

Other aspects of the invention will become apparent by consideration of the detailed description and accompanying drawings.

### BRIEF DESCRIPTION OF THE DRAWINGS

FIG. 1 is a flow chart illustrating an embodiment of a manufacturing process.

It should be understood that the invention is not limited in its application to the details of construction and the arrangements of the components set forth in the following description or illustrated in the above-described drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

A “polyurethane foam” as used herein refers to polymers that contain the molecular structure of urethane—(—NH—CO—O—)—, urea—(—NH—CO—NH—)—, or both. Such polymers are typically obtained by reacting polyisocyanates with isocyanate-reactive compounds such as polyols, often using foaming agents.

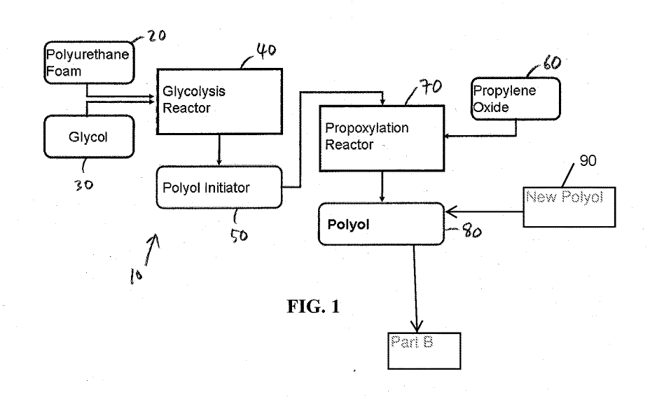

FIG. 1 is a flow chart illustrating an embodiment of a manufacturing process 10 for recycling polyurethane foam scrap to form a recycled polyol (i.e., the recycled polyol of Part B in the above formula). First, polyurethane foam scrap 20 is dissolved in the reactant glycol 30 inside a glycolysis reactor 40 at a suitable reaction temperature to form a polyurethane solution 50. In some embodiments, the polyurethane foam scrap 20 comprises about 1% or more, 5% or more, about 10% or more, about 15% or more, about 20% or more, about 25% or more, about 30% or more, about 35% or more, about 40% or more, about 45% or more, about 50% or more, about 55% or more, or about 60% or more of scrap material. Suitable glycol 30 may include diethylene glycol, recycled glycol from antifreeze, or natural oils such as castor oil. The glycolysis results in depolymerization of the polyurethane foam into urethane and urea bonds. Although FIG. 1 illustrates a glycolysis process for depolymerization, it is to be appreciated that other embodiments may utilize other suitable chemolysis processes such as hydrolysis with water as the reactant, or aminolysis with amine as the reactant. In some embodiments, the glycolysis or other suitable chemolysis may result in about 45% or more, about 50% or more, about 55% or more, about 60% or more, about 65% or more, about 70% or more, about 75% or more, about 80% or more, about 82% or more, about 84% or more, about 86% or more, about 88% or more, about 90% or more, about 91% or more, about 92% or more, about 93% or more, about 94% or more, about 95% or more, about 96% or more, about 97% or more, about 98% or more, or about 99% or more of depolymerization of the polyurethane foam 20.

The depolymerized polyurethane foam 20 initially forms a polyurethane solution 50, also referred to as polyol initiator. The polyurethane solution 50 is filtered to remove any impurities or contaminants that are not glycolyzed. The filtered polyol initiator is then combined with propylene oxide 60 in a propoxylation reactor 70. During the propoxylation, the molecular weight distribution and the molecular weight of the final polyol product 80 can be suitably adjusted. Thus, the density of the polyol product 80 can be tuned depending on the usage requirements or preferences for the particular application.

New polyols 90 are added to the polyol product 80 to form Part B in the above formula. The Part B mixture is blended or mixed with Part A (e.g., virgin isocyanate) in a mixer. After a suitable rise time, polyurethane foam will form. The foam may be subsequently cured by contacting the foam with hot air. In concrete lifting, the foam may be injected under a slab to fill voids and raise the slab.

In one embodiment, Part B is manufactured by the following steps:
a. In an appropriate sized vessel, PFC11A (e.g., InfiGreen 420A) is dispensed.
b. Under low speed (low shear blade), PFC11E (e.g., InfiGreen 420E) is gradually added.
c. When the mixture of a. and b. is homogeneous, PFC4 (e.g., TCPP) is added.
d. When the mixture of a., b., and c. is homogeneous, PFC7 (e.g., JeffCat ZF-10) is added.
e. The mixture is rotated from the bottom of the vessel into the top of the vessel. When the mixture of a., b., c., and d. is homogeneous, PFC5 (e.g., NIAXX A-33/Cellcat 33) is added.
f. When the mixture of a., b., c., d., and e. is homogeneous, PFC15 (e.g., Dabco T-12 Catalyst) is added.
g. PFC901 (e.g., black dye) is added to the mixture.
h. When the mixture of a., b., c., d., e., f., and g. is homogeneous, PFC903 (e.g., InfiGreen Catalyst) is added.
i. When the mixture of a., b., c., d., e., f., g., and h. is homogeneous, water is added.

The components of Part B noted in the steps above result in the following ratio for a high density foam used for lifting heavy slabs, such as for highways and industrial flow projects with heavy traffic:

| | | |
|---|---|---|
| PFC11A | InfiGreen 420A | 55.88% |
| PFC11E | InfiGreen 420E | 33.54% |
| PFC4 | TCPP | 8.36% |
| PFC7 | JeffCat ZF-10 | 0.08% |
| PFC5 | Niax A-33/Cellcat 33 | 0.22% |
| PFC15 | Dabco T-12 Catalyst | 0.08% |
| PFC901 | Black Dye | 0.55% |
| PFC903 | InfiGreen Catalyst | 0.09% |
| PFC8 | Water | 1.20% |

InfiGreen 420A and InfiGreen 420E are polyols manufactured by InfiChem Polymers LLC. TCPP is tris (1-chloro-2-propyl) phosphate. JeffCat ZF-10 is an amine catalyst manufactured by Huntsman International LLC. Niax A-33/Cellcat 33 is a catalyst manufactured by Momentive Performance Materials Inc. Dabco T-12 Catalyst is a catalyst manufactured by Air Products and Chemicals, Inc. InfiGreen Catalyst is a catalyst manufactured by InfiChem Polymers LLC.

For example, the net filling weight for a drum is 450 lbs. Based on the ratios in the table above, the resulting amounts for each component of Part B for a drum is:

| | | | | |
|---|---|---|---|---|
| PFC11A | InfiGreen 420A | 55.88% | 251.4600 | lbs |
| PFC11E | InfiGreen 420E | 33.54% | 150.9300 | lbs |
| PFC4 | TCPP | 8.36% | 37.6200 | lbs |
| PFC7 | JeffCat ZF-10 | 0.08% | 0.3600 | lbs |
| PFC5 | Niax A-33/Cellcat 33 | 0.22% | 0.9900 | lbs |
| PFC15 | Dabco T-12 Catalyst | 0.08% | 0.3600 | lbs |
| PFC901 | Black Dye | 0.55% | 2.4750 | lbs |
| PFC903 | Infigreen Catalyst | 0.09% | 0.4050 | lbs |
| PFC8 | Water | 1.20% | 5.4000 | lbs |

An illustrative embodiment of the system and method of manufacturing polyurethane foam for concrete lifting is described below.

### EXAMPLE

Polyurethane foam scrap was purchased from a commercial source. The purchased scrap material was put into a grinder and super-heated in a glycolysis reactor with glycol. The resulting polyurethane solution was combined with propylene oxide to form a polyol product. The polyol product was blended with new polyols and virgin isocyanate to form polyurethane foam. The gel time for the foam was about 15 seconds. The exothermic peak was at about 110° C., which was at about 24 seconds after the mixing. The tack-free time was about 51 seconds.

The average density of the resulting polyurethane foam was measured according to ASTM D1622 as about 64 kg/m³. The peak compressive strength was measured according to ASTM D1621 as about 0.62 MPa at a peak strain of about 7%. The compressive yield stress was measured as about 0.69 MPa at a yield strain of about 8%. The average tensile strength was measured according to ASTM D1623 as about 0.59 MPa at an elongation of less than about 5%. The average volume change during thermal and humid aging was measured according to ASTM D2126 as less than about 1%.

It is understood that the invention may embody other specific forms without departing from the spirit or central characteristics thereof. The disclosure of aspects and embodiments, therefore, are to be considered as illustrative and not restrictive. While specific embodiments have been illustrated and described, other modifications may be made without significantly departing from the spirit of the invention.

Various features and advantages of the invention are set forth in the following claims.

What is claimed is:

1. A polyurethane foam for lifting concrete, the polyurethane foam comprising:
a sufficient amount of a first polyol comprised of recycled polyurethane foam;
a sufficient amount of a second polyol; and
a sufficient amount of isocyanate.

2. The polyurethane foam of claim 1 wherein the first polyol comprises about 10% to about 20% when the first polyol and the second polyol are combined.

3. The polyurethane foam of claim 1 wherein the first polyol comprises about 21% to about 30% when the first polyol and the second polyol are combined.

4. The polyurethane foam of claim 1 wherein the first polyol comprises about 31% to about 40% when the first polyol and the second polyol are combined.

5. The polyurethane foam of claim 1 wherein the first polyol comprises about 41% to about 50% when the first polyol and the second polyol are combined.

6. The polyurethane foam of claim 1 wherein the first polyol comprises about 51% to about 60% when the first polyol and the second polyol are combined.

7. The polyurethane foam of claim 1 wherein a combination of the first polyol and the second polyol has a 1:1 ratio with the isocyanate to form a polyurethane foam.

8. A polyurethane foam for lifting concrete, the polyurethane foam comprising:
a first component comprised of first recycled polyurethane foam;
a second component comprised of a second recycled polyurethane foam;
a third component comprised of tris (chloroisopropyl) phosphate;
a fourth component comprised of a first catalyst;
a fifth component comprised of a second catalyst;
a sixth component comprised of a third catalyst;
a seventh component comprised of water,
wherein the first, second, third, fourth, fifth, sixth, and seventh components are combined, and
wherein the first component comprises at least about 50% of the combination, the second component comprises at least about 30% of the combination, the third component comprises at least about 8% of the combination, the fourth component comprises at least about 0.05% of the combination, the fifth component comprises at least about 0.2% of the combination, the sixth component comprises at least about 0.05% of the combination, and the seventh component comprises at least about 1% of the combination; and
a sufficient amount of isocyanate.

9. The polyurethane foam of claim 8 further comprising an eighth component comprised of a black dye, and wherein the eighth component is added to the combination, and wherein the eighth component comprises at least about 0.5% of the combination.

10. The polyurethane foam of claim 9 further comprising a ninth component comprised of a fourth catalyst, and wherein the ninth component is added to the combination, and wherein the ninth component comprises at least about 0.05% of the combination.

11. A method of lifting concrete, the method comprising:
combining a sufficient amount of a first polyol comprised of recycled polyurethane foam with a sufficient amount of a second polyol to form a first part;
adding a sufficient amount of isocyanate to the first part to generate a polyurethane foam;
pumping the polyurethane foam into voids in concrete to move the concrete from a first elevation to a second elevation.

12. The method of claim 11 wherein the first part and the isocyanate have a 1:1 ratio.
